(19) United States
(12) Patent Application Publication
(10) Pub. No.: US 2016/0357582 A1
(43) Pub. Date: Dec. 8, 2016

(54) METHOD TO CONFIGURE A MANAGEMENT PROGRAM

(71) Applicant: Microsoft Technology Licensing, LLC, Redmond, WA (US)

(72) Inventors: Valeria NALDI, Bologna (IT); Carlo PESCIO, Bologna (IT)

(21) Appl. No.: 15/109,606

(22) PCT Filed: Aug. 4, 2014
(86) PCT No.: PCT/EP2014/002141

§ 371 Date: Jul. 1, 2016

(30) Foreign Application Priority Data
Aug. 27, 2013 (IT) MI2013A001413

(51) Int. Cl. G06F 9/445; G06F 3/0484

(52) U.S. Cl. CPC G06F 9/44505; G06F 3/0484

(57) ABSTRACT

A method to configure an information system with a plurality of interconnected users, in which users shall not write nor modify the source code of the program, but have the possibility of forming the desired types by accessing, via appropriate interface systems, a set of concepts organized into libraries, and selecting, by way of appropriate means, the concepts necessary to form types.

### TECHNICAL FIELD

The present invention makes reference to the company information systems in all industrial sectors, provided as a service via remote hosting, by taking advantage of the potentials of the so called cloud computing in order to get a greater computation capacity and potentially unlimited data storage and conservation capabilities.

### STATUS OF THE ART

Company management information systems (for instance, CRM, PLM, MRP) are widely used in all industrial and commercial sectors. They usually feature graphical interfaces through which users enter the data to store according to predetermined fields (for instance, “weight” and “orders” fields) which are displayed on said interfaces. The stored data can subsequently be updated and processed according to the user's needs, on the basis of the system's logics, as created by its provider. In the currently marketed systems, the fields predetermined by the provider are, in principle, intelligent (i.e. they conform to logics and validations of different types), whereas the fields entered by users do not have a logic of their own, apart from elementary validations, but they just reflect the fields of the data base progressively created by the individual users themselves. For instance, a user can add a “from” field and a “to” field to model a range of values, but in no way can he add a validation between these fields (“from” less than “to”) and a computation of the width of the range (from-to), unless, as specified below, he writes an ad hoc code, provided such an option is offered by the provider.

The advent of cloud computing solutions made management programs usable according to SaaS (SaaS=Software as a Service) models. Said programs are resident in cloud-like platforms, together with the data entered, updated and processed by the individual users via remote interfaces, connected to the platform by way of appropriate communication means. A characteristic of the SaaS system consists of the possibility for the platforms of being used in every instant by several users, each of whom a virtual space is dedicated in order to load and process data. Numerous are the platforms that host standard management programs and make it possible for users to customize the program through the interface and to configure it according to the specific requirements of the individual users or the specific industrial sector or the specific company. Said customization usually takes place through a creation of new type entities or simply types (for instance, by defining a new type of “customer” entity) or through a modification of already existing types. The definition of new types and the modification of existing ones usually take place at the level of the individual fields, which graphically represent just spaces into which data is entered. Usually said fields do not manifest any behaviour, apart from validating the data item entered or formatting it according to the specifications set by the service provider.

Some platforms make also it possible to set links or relations between the various entities, where said relations do not add any specific behaviour, but a connection between the entities, hence the possibility of browsing from an entity to another one related thereto. Configuration and customization are important activities to offer flexibility to the management information systems and to adapt a standard product to the requirements of the individual users.

According to the present status of the art, provider only allow the configuration or customization of management programs on a cloud platform in the form of addition of logicless fields or creation of logicless types or relations. As a matter of fact, the addition of logic by a user would entail his access to the platform's code and the writing of a specific, modificative or additional, code, following the provision of programming interfaces by the provider.

A solution like this for the configuration presents major technical problems which might jeopardize the operation of the platform. A user writing a code and loading it onto the platform with the purpose of improving its features basically results in major problems in terms of program stability, data security, and platform reliability.

In the case of a multi-user platform it is statistically impossible to determine whether a code written by a user will result in an over-exploitation of the computation and storage capacities, consequently system slowdowns and/or blackouts and/or instability situations might occur, with the consequent increases of costs and energy consumptions.

A technical solution currently used to face the just described problem is that of only allowing a code modification through a proprietary language set by the service provider which, via an interpreter, performs a continual monitoring, for instance in order to check for excessive memory and CPU consumptions and, if necessary, forcedly terminates the logics set by users.

However, a disadvantage of such a solution consists in that checks are to made on all users of the platform and in no way is it a real solution of the problem, in that it just gives the possibility of heuristically diagnosing situations of over-exploitation of the computation capacities of the platform due to the proposed modifications.

According to the present status of the art there are no efficient, safe, and low-cost solutions that make it possible for a user to configure in a simplified manner and in real time the management system in a multi-user platform that simply makes use of data display and entry interfaces, but through the necessary writing of a code by that user and its consequent interaction with the code of the management system.

### DESCRIPTION OF THE INVENTION

The present invention can be advantageously used to configure management programs on multi-user platforms in a variety of industrial and commercial sectors including for instance, but not limited to, the product lifecycle management field.

This invention concerns a management program configuration system, in which a user, via a system of interconnected computers and interfacing devices like, for instance, keyboards, monitors, and mice, accesses libraries that contain the concepts, i.e. the basic structural or relational units, provided with a behaviour, provided by an application. The concepts are created by the platform developers as independent units, each of them defining its own data, its own behaviours, and its own graphical representation, for instance “weight” or “expiration date”.

Said concepts are either structural concepts (for instance, physical quantities) or relational concepts. The structural concepts will typically be characterized by a concept behaviour and by a graphical representation mode; the relational concepts will be typically characterized by a possible relation, by a concept behaviour, and by a graphical representation mode, as better illustrated below.

Thanks to the access to the concept libraries via interfacing devices, a user can set new type entities and customize the information system, even in successive stages and later in time, by simply displaying the existing concepts, selecting them, aggregating structural concepts, and connecting the type entities by means of relational concepts, without any need for interacting with the source code to create new type entities, to set relations, or to make the fields conform to that user's logic.

In the management systems according to the present status of the art, the interaction between a user and the system is just limited to the compilation of predetermined fields, which reflect the logic of the data bank preset by the platform provider and to the preset logics. To be able to modify this logic, a user shall write a specific code of his own, which results in the problems described above. In the present invention, on the contrary, users interact with the system, by selecting and aggregating the concepts available inside the libraries, displayed and selected by means of appropriate means; aggregating concepts, not writing a code, is the only activity a user shall perform.

An example of a structural concept and of a significant behaviour is that of “weight”. The concept of weight is made available together with the behaviour represented by the capability of being converted into another measuring unit. This way, if a system user needs to convert the digits that express a weight in its relevant field, he shall not write a source code to enable the program to this conversion, because its respective logic is already present inside the concept. Likewise, if a user has to link an entity to a second entity, the need for making the exact meaning of this link explicit is not met by drawing up a specific source code, but through the selection of a relational concept, which already owns the information related to the requested significant behaviour (for instance, the “composition” relation owns the capacity of representing, in a hierarchical and multilevel manner, how a structure is made up, i.e. the component parts that determine it).

The simplified interaction a user shall make according to the present invention, thanks to the availability of structural and relational concepts, to be displayed, selected, and aggregated to form the desired type entities, solves the known problems affecting the present systems, in that it does not requires users to write a special code, minimizes the use of the computation capacity and of the time of use of the machines, with a consequent energy saving, and prevents user overloads which might jeopardize the operation of the system whenever several users are simultaneously connected to.

The following examples identify some indicative, not exhaustive embodiments of the present invention. Consider a mechanical part “A”. Among its many properties, this mechanical part features a “thickness” and a “weight”. In a traditional management system the weight would be represented as a field containing digits, because it is through this field that the data relevant to the concerned mechanical part is entered in its respective data bank,

Meant as a property of the mechanical part, the weight also has a number of behaviours associated therewith, for instance its capability of being converted into other measuring units. Moreover, there are also characteristics of the interface related to the weight, which allow a user to select, for instance, the measuring units he would like to use to express the weight. According to the present invention, the concepts-based system makes it possible for a user to customize the system with respect to the “part”, by selecting and assembling the concept of “weight” already available inside libraries, and to display it according to the characteristics comprised therein, for instance the measuring unit, the conversion, and a corresponding displaying mode. Everything in real time and without the need for writing a specific source code.

A second example concerns system configuration whenever it is necessary to create a relation between the quantities defined inside several entities, for instance the need for drawing up a parts list and for being able to sum together someone of the quantities (concepts) set inside the entities that make this parts list up. The relational concepts present in libraries inside the system present displaying modes, through which users can display which are the related to entities and select them. The relational concepts are capable of composing their own behaviour with that of the structural concepts. The “formed of” relational concept (which abstracts the various relations: “contained by”, “assigned to”, “owned by”) is capable of relating itself to the type entities through the metadata of said entities and of determining possible expressions/operations between these metadata items. For instance, in forming a parts list, a user can decide whether to make the concepts of weight by quantity summable to determine the total weight, whereas he might set the concept of thickness as not summable one, and consequently a total thickness would not be computed. Without any need for writing a source code, the system will be configurable to draw up a parts list through the various structural concepts (“weight”) and relational concepts (“formed of”) by simply displaying and selecting them and displaying their respective graphical interfaces for their use.

1. Simplified method for configuring a computer system with a plurality of users connected simultaneously, including:
(1) A system of interconnected computers;
(2) Means of storage of concepts organized in libraries
(3) Means suitable to display concepts organized in libraries
(4) Means for the selection of concepts organized in libraries
Characterized in that
said concepts are formed by components suitable to the creation of types and to the definition of at least one behavior and at least one corresponding graphical representation of said concepts
and further characterized by the fact that
the user of the system shapes the information system showing the general concepts organized in libraries, by selecting within those libraries at least one type of concepts and inditing the selected type.

2. Method according to claim 1, in which the structural concepts are a set of components defining at least a behavior and at least one graphical representation of said concepts.

3. Method according to claim 1, in which the connection concepts are a set of components defining at least a behavior and at least one graphical representation of the connection.

4. Method according to one of the preceding claims in which the compound types are constructed by composing structural concepts and related by connection concepts.

5. Method according to one of the preceding claims in which the types allow the connection concepts connecting themselves to manifest at least a logical behavior or display emerging from the cooperation of said connection concepts with structural concepts composing the types themselves.

6. Method according to claims 1-4 in which the user of the system shapes the information system parameterizing both the behavior and the modality of displaying the general concepts organized in libraries.

7. System according to claim 1, in which the concepts are specific components of a definite industry or commodity.

8. System according to one of the preceding claims, in which the types are created or modified also later.
